(19) United States
(12) Patent Application Publication
(10) Pub. No.: US 2010/0263555 A1
(43) Pub. Date: Oct. 21, 2010

(54) Salad, rice and other foods washer and spinner

(76) Inventors: Pat Y. Mah, Kowloon (HK); Alexander Joshef Kalogroulis, Coulsdon (GB); K.K. Tung, Kowloon (HK); Michael Ng, Medindie (AU)

Correspondence Address: Harrington & Harrington, P.O. Box 91719, LONG BEACH, CA, 90809-1719, US

(21) Appl. No.: 12/386,439

(22) Filed: Apr. 17, 2009

(51) Int. Cl. A47J 43/24

(52) U.S. Cl. 99/495

(57) ABSTRACT

A salad, rice and other foods washer and spinner includes an angled bowl and cover with a cranking handle that turns a basket and basket lid inside the bowl via a gear set. A twin speed gear set is disclosed which allows a different velocity of spin when the cranking handle is turned in one direction than when it is turned in the other direction. A bowl is angled with respect to a base member and a covering lid includes water inlet on a higher side of the lid that allows water from a faucet or jug to be directed through the cover and onto the basket lid where it is dispersed into the basket volume via holes in the basket lid, with water escaping, if desired through an outlet grille.

### FIELD OF THE INVENTION

The present invention relates to an improvements in the design, capabilities and operation of a salad, rice and other foods washer and spinner that will give the capability to more completely remove impurities, including a tilted flow through design which provides for continuous washing.

### BACKGROUND OF THE INVENTION

The washing of foods is becoming increasingly important for a number of reasons. Increased food trade with countries with relaxed food production standards increasingly utilize improper techniques. Contamination can result from materials which remain on the food such as pesticides, herbicides, fertilizers, as well as common dirt and dust. Even so called “organically grown” foods will contain undesired material.

The dangers of food contamination are well known. In addition to unwanted particulate matter contamination, chemical agents can cause both short and long term ill effects. Nearly everyone has lost days to sickness due to food contamination. In extreme circumstances, food contamination can result in death.

To attempt to wash food, techniques employed range from running water over the food, to soaking the food to dipping the food in water containing a mild oxidizing or reducing agent, or a mild soap, in the hope that the agent can come into contact with the organic contaminant and either render it harmless, or facilitate the removal of unwanted organics. However, where a chemicals oxidizing or reducing agent is left in contact with the food, it can cause flavor diminution. Leaving the food in contact with the purifying agent, or simply leaving the food in contact with water for a long time can cause water (and agent) absorption and change the firmness and other aspects of the food.

Insofar as is known, no device or method has existed to quickly wash and treat food in a way which will help insure that the food will undergo maximized contact and cleaning in such a way in which the food will not be changed. No device is known to have offered a thorough contact with mild oxidizing or reducing agent, or a mild soap, with the ability for significantly shortened time of contact. What is needed is a washing device which is safe, convenient, and efficient. The needed safety, convenience, and efficiency characteristics will encourage food to be washed more often, and will encourage consumers to consume healthier foods.

### SUMMARY OF THE INVENTION

A salad, rice and other foods washer and spinner includes an angled bowl and cover with a cranking handle that turns a basket and basket lid inside the bowl via a gear set. The cover houses the gear set and cranking handle and also has a water inlet on its higher side that allows water from a faucet or jug to be directed through the cover and onto the basket lid where it is dispersed into the basket volume via holes in the basket lid. Water may fill the angled bowl until the user stops adding water, or if the washer is placed into a sink or onto a draining board, until the water begins to pour out from the outlet grille on the lower edge of the cover. If the user allows a continuous flow of water to flow through the basket and simultaneously turns the cranking handle, the contents of the basket will be circumferentially agitated with an upper portion raised and lowered with regard to the water level.

When the water level in the bowl is low the food material will be dipped and dragged through the water, and when the water level in the bowl is high, the food material may receive a sprinkling of water via the basket lid. Thus it may be preferable for less than all the contents to submerged during cranking, depending upon the most prominent desired effect.

The effect is to gently wash the contents in agitated water and allow the pesticides, herbicides and dirt to flow away in the water stream. For particularly dirty items, the user can stop filling the bowl when the water level reaches a water fill line on the bowl. Gentle cranking of the handle will then allow the contents to be soaked, agitated and washed with or without flowing water. The user can also tip up the bowl to empty the dirty water and then refill and repeat as necessary. For items that are generally rounded, e.g. potatoes, brussels sprouts etc., the angled bowl and gentle cranking leads to a gentle tumbling of the contents inside the basket that aids and speeds up the cleaning process. This is particularly useful for dirty items such as new potatoes. Any dense particles such as stones or grit may be allowed to collect at the bottom of the bowl and fall into a dirt trap that consists of recessed slots. This dirt trap stops the particles being flushed back into the items being washed by turbulence.

When washing has finished, the excess water can be drained out via the outlet grille in the cover. The cranking handle can then be turned again to spin dry the contents. This is particularly suited to salad greens where a high speed can drive out a lot of excess water. This water will collect at the bottom of the bowl between the bowl and the spinning basket. Heavy particles will once again drop into the dirt trap slots. In one embodiment a crank may be provided which will cause the basket to move at a slower speed when cranked in one direction and at a higher speed when cranked in the opposite direction.

The Salad, rice and other foods washer and spinner can also be used for herb washing and is facilitated for use for rice washing with a rice wash attachment. To facilitate herb washing, a pair of clip in mesh panels allows the basket to be subdivided into compartments. Delicate or small items can be placed into these compartments for washing without fear of them being overly tumbled or getting mixed up with other items being simultaneously washed. Further, as the side partition forms a separate space at the outer part of the basket which will have more of an immersing and draining action as the basket turns.

For rice washing, basket and basket lid can also be removed and replaced by a single rice paddle to agitate rice during washing. The rice is added along with some water and the handle is cranked for a few seconds. The water is then poured out though the outlet grille (along with the excess starch). The cycle is then repeated until the drainage water is sufficiently clear. Alternatively, the washer can be placed into a sink or onto a draining board and water allowed to gently flow continuously into the water inlet and out of the outlet grille whilst simultaneously agitating the rice using the crank driven paddle. When the water runs sufficiently clear the washing is complete and excess water can be drained by inverting the unit and allowing the water to drain out of the outlet grille.

Other optional features include the provision of a brake function that may be provided to slow down the spinning basket. This consists of a wear pad on the underside of the water inlet bottom face that can be brought into contact with a matching face on the basket lid by the user's pressing down on the top face. The brake function can therefore be provided without the need for any extra components.

Dual or twin speed can be provided to operate without special switching, perhaps simply by reversing the direction of turn of the handle. Due to the inertia and viscosity of water, and the close proximity of the basket to the bowl, it is noticeably more difficult to crank the handle when the basket is being forced to move through water during the washing cycle. Whilst it would be possible to reduce the gear ratio to ease cranking, this would limit the effectiveness during spin drying when the same gear ratio limits the upper rotational speed of the basket. It is therefore advantageous to have a means to change gearing. Two methods are presented, both of which are allow a different gear ratio depending on whether the handle is being cranked clockwise or counterclockwise.

One technical method to attain a dual or twin speed is with ratchets. In this arrangement, both an internal and an external gear ring, with a common centre, act on the same drive gear. Both internal and external gear rings obtain their input motion from the same drive disc that is cranked in a conventional manner via a turning handle. However the interface between each gear ring and the drive disc consists of a one way ratchet and the two gear rings have ratchets that act in opposite rotational directions. In this way, when one gear ring is locked to the drive disc and transmitting motion to the drive gear, the other gear ring is being driven in the opposite direction by the same drive gear and being allowed to slip by the ratchet. If the drive disc is then turned in the opposite direction, even during a sudden change in direction, the ratchet that was slipping now starts to transmit the rotational input to the drive gear. The opposite gear ring is now forced to turn in the opposite direction by the drive gear and is allowed to do so its ratchet slipping. As the internal and external gear rings have different numbers of teeth, the gear ratio is switched depending on whether the drive disc is being rotated clockwise or counterclockwise. When the drive disc is released, the ratchets al low the rotating basket to over run.

A second possible arrange may include dual or twin speed with floating gears. In this arrangement, both an internal and external gear ring are mounted on the drive disc but neither gear ring actual engages the drive gear. Instead there are a pair of small idler gears one of which is always driven by the external gear and can be swung into engagement with the drive gear and the other always in engagement with the internal gear and also able to be swung into contact with the drive gear. The two idler gears are both mounted on a common platform that rotates (floats) about the common centre of the drive disc and internal and external gears. The idler gears may be positioned on either side of the drive gear and spaced apart in such a way as to ensure that it is not possible for both of them to touch the drive gear simultaneously. When the drive disc is rotated in a given direction, one of the idler gears is urged into engagement with the drive gear whilst the other is pushed away by virtue of being on a common platform. The drive gear will then be driven by the drive disc by the engaged idler gear. If the rotation of the drive disc is reversed, the idler gear that was in engagement is immediately driven out of engagement and the other idler gear moves into engagement. As the internal and external gears have different numbers of teeth, the gear ratio is switched depending on whether the drive disc is being rotated clockwise or counterclockwise. When the drive disc is released, the idler gears both move to a non engaged position so the rotating basket over runs freely.

The angled bowl has a molded in dirt trap and pivot for rotatably supporting a basket. A rubber base is attached to the base of the bowl to provide grip. A basket sits on the pivot and can have a pair of herb compartment dividers slotted into it. A cover fits over the bowl and supports a drive disc with integrated internal gear. A central drive gear passes through the cover and is driven by the internal gear of the drive disc. A handle is provided on the drive disc. On the bowl side of the drive gear, a quick release shaft is provided to receive and drive the basket lid. The basket lid has lugs at its periphery that engage with the basket when the cover/basket lid are lowered into place. When used for rice washing, the basket and basket lid are removed and a rice paddle is placed on the bowl pivot. The drive gear passes over the drive end of the rice paddle and internal teeth drive the rice paddle to agitate the rice.

### BRIEF DESCRIPTION OF THE DRAWINGS

The invention, its configuration, construction, and operation will be best further described in the following detailed description, taken in conjunction with the accompanying drawings in which:

FIG. 1 is a perspective exploded view of a composite first embodiment of the salad, rice and other foods washer and spinner of the invention and illustrating an upper view looking down onto the parts which cooperate to form the apparatus;

FIG. 2 is a perspective view of the salad, rice and other foods washer and spinner of FIG. 1, but seen in an assembled condition as it would be during use;

FIG. 3 is a perspective view looking at the bottom of a basket drive lid seen in FIG. 1 while it is still mechanically engaged with the cover which was seen in FIGS. 1 and 2;

FIG. 4 is a perspective view of the underside of the lid and illustrating the rotational snap engagement member and brake wear pad;

FIG. 5 is a perspective expanded view of the underside of the drive disk illustrating the set of circumferentially inwardly disposed drive teeth and their engagement with a driven gear 103;

FIG. 6 is an expanded perspective view looking into the basket which is engaged with an optional pair of herb dividers shown attached to the basket;

FIG. 7 is a perspective isolated view of one of the dividers seen in FIG. 6 in an un-flexed view and illustrating further details;

FIG. 8 is a perspective view from below looking upward into the bowl assembly without the basket and showing the shape and location of the rotational support cone projection;

FIG. 9 is a sectional view taken along line 9-9 of FIG. 8 and illustrates the orientation of the troughs and rotational support cone projection;

FIG. 10 is a perspective upper view looking down into the bowl assembly with the basket loaded into place and in condition to be loaded with a food to be washed;

FIG. 11 is a perspective upper view looking down into the bowl assembly with the basket seen in FIG. 10 removed and with a stirring paddle loaded into place over the rotational support cone projection, and prior to the introduction of rice to be washed;

FIG. 12 is a perspective view of the underside of the cover and illustrating the stirring paddle;

FIG. 13 is a plan view illustrating the first of two methods of achieving twin speed action, this first plan view utilizing directional clutches mounted between an inner gear and an outer gear which engages a driven gear;

FIG. 14 illustrates a second twin speed gear arrangement in which a pair of intermediate drive gears are supported by an angled gear support, with the intermediate drive gears able to shift position to make an intermediate engagement between the an outer gear and a driven gear or between an inner gear and a driven gear depending upon the direction with which the main gear is turned, and with FIG. 14 illustrating the neutral position;

FIG. 15 is a view as in FIG. 14 but illustrating clockwise movement of drive disk causing contact between the outer drive teeth, first intermediate drive gear and thence to the drive fitting; and

FIG. 16 is a view as in FIGS. 14 and 15 but illustrating counterclockwise movement of the drive disk causing contact between the drive teeth via the second intermediate drive gear to the drive fitting.

### DETAILED DESCRIPTION OF THE PREFERRED EMBODIMENT

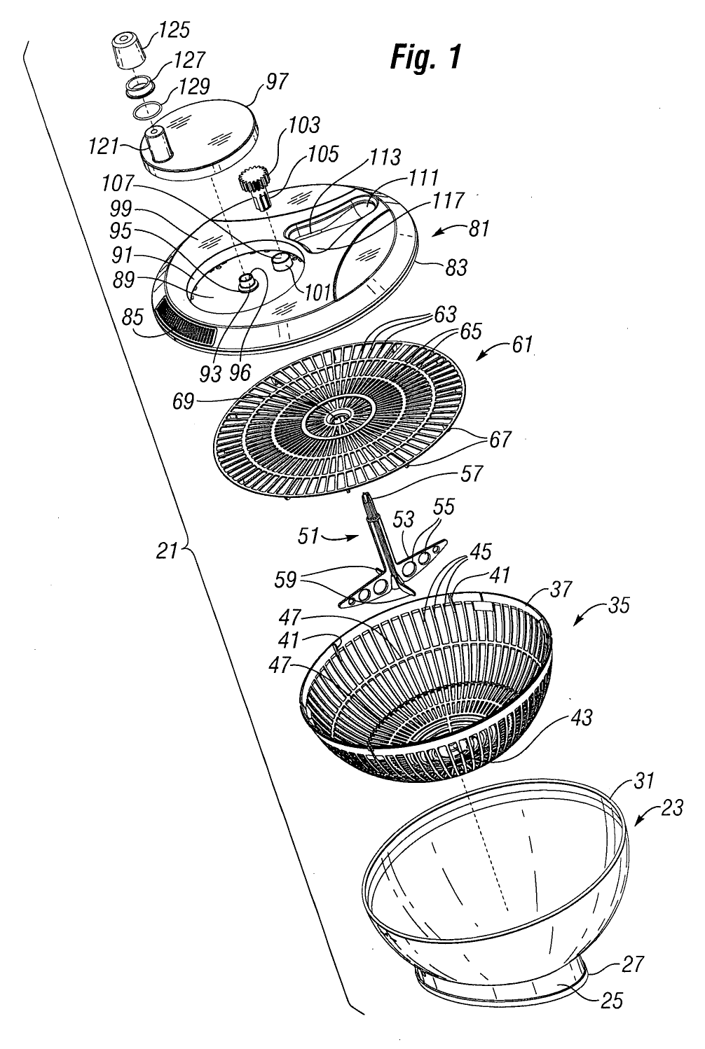

The description and operation of the salad, rice and other foods washer of the invention is best begun with reference to FIG. 1 which illustrates is an exploded view of looking down onto the parts which cooperate to form the apparatus. The salad, rice and other foods washer and spinner 21 will be explained beginning at the lowermost extent of the vertically exploded members. A bowl assembly 23 includes a base member 25 which may have a rubber base 27 covering lower rim for good, slide-resistant operating support. A bowl member 31 is supported, preferably at an angle with respect to base member 25. The angle of support for a fixed embodiment shown may be from about twenty to about forty degrees. In addition, a variable embodiment may be provided where the user can adjust the angle of the bowl member 27 with respect to the base member 25, as desired by the user.

Seen above the bowl member 23 is a basket 35 which can be of almost any type but preferably will be concentrically balanced and have ample openings to admit and transmit water freely. The basket has an upper rim 37 which is generally closed for about 1-2 centimeters about its upper periphery to give upper structural integrity and to support a series of circumferentially inwardly directed engagement ribs 41 which will be used to drive the basket 35. Basket 35 has a central rotational aperture 43, located at a rotational center of said basket 35, and which can be seen through several of the vertical curving ribs 45. Also seen are several horizontal ribs 47. It is understood that the basket 35 can assume a variety of different shapes.

Above the basket 35, an optional stirring paddle member 51 is seen. It is contemplated that the stirring paddle would be utilized in absence of the basket 35 and that stirring will occur with the stirring paddle member 51 used directly with respect to the bowl 31. The stirring paddle member 51 may have a series of blade projections 53 with a series of apertures 55 which may lessen the stirring resistance. The stirring paddle member 51 may have an upper insertion portion 57 which may aid in rotational insertion into a drive structure (to be discussed). Also seen are two optional side paddle blades 59 which may be used to give the paddle more support and better balance.

Above the stirring paddle member 51 is a basket drive lid 61 which has a series of radial ribs 63 and may have a series of circumferential ribs 65 crossing the radial ribs 63 at right angles. Near an outer periphery of the basket drive lid 61, a series of downwardly directed locating lugs 67 are used to engage the circumferentially inwardly directed engagement ribs 41 within the basket 35 in order to drive rotation of the basket 35 along with the basket drive lid 61. At the center of the basket drive lid 61, a drive aperture 69 has structures partially seen which will mechanically engage the basket drive lid 61 in order to impart rotational force to the basket drive lid 61 and basket 35 when engaged with each other as a unit. It may also be preferred that the optional stirring paddle member 51 operate without the basket drive lid 61 with the stirring paddle member 51 to obtain drive force directly and without the aid of the basket drive lid 61.

Above the basket drive lid 61 is a cover 81 supporting mechanical drive components which are shown in exploded view to facilitate a further description thereof. Cover 81 has an outer periphery 83 for engaging an upper rim of the bowl member 31. At one side of the cover 81 and adjacent the outer periphery 83 is a outlet grille 85 which may consist of a series of closely spaced slots in order to permit water drainage or overflow without providing so large of an opening that moisture will be excessively spirally thrown out during spinning.

Also seen with respect to the lid 81 and adjacent the outlet grille is a circular depression having a circular depression flat space 89 adjacent a circular depression vertical wall 91. At the center of the circular depression flat space 89, a boss 93 has a reinforced base structure 95. Boss 93 surrounds a drive disk anchoring bore or aperture 96. The boss 93 supports turning engagement with a drive disk 97. Drive disc 97 is sized to fit within circular depression flat space 89 and generally flush with a top surface 99 adjacent a circular depression vertical wall 91.

Also within the circular depression flat space 89 is seen a driven gear boss 101, above which is positioned a driven gear 103 with a, possibly integral, combination lower basket lid 61 and stirring paddle member 51 drive fitting 105 extending below it. The drive fitting 105 fits through a central aperture 107 in the driven gear boss 101. The drive fitting 105 fits through and its rotationally supported by the driven gear boss 101. The circumferential size of the gear boss 101 supports and provides an increased and stable bearing area to support the driven gear 103 and drive fitting 105.

At the other side of the lid 81, a depression 111 is seen. The depression 111 forms a water guiding and splash containment reservoir at the outermost circumferential part of the lid 81, with the other end of the depression containing a flow through slot 113 at the other end of the depression 111 near the inside. The flow through slot 113 is a narrow extended slot which evenly extends about the inner portion of the reservoir to form a cantilever brake portion 117 which may be depressed at the conclusion of the spinning operation to form a friction brake against the top of the basket drive lid 61. During the filling stage, water may be conveniently introduced into the depression and fill the inside of the bowl 31 by virtue of the water running through the narrow flow through slot 113.

The drive disk 97 has an upwardly projecting member 121 as a handle, but is fitted with a rotatable handle 125 so that the user can grasp the rotatable handle 125 rather than the upwardly projecting member 121 which would otherwise produce friction against the user's hand. A slip bearing 127 and ring 129 is provided for secure bearing and stability.

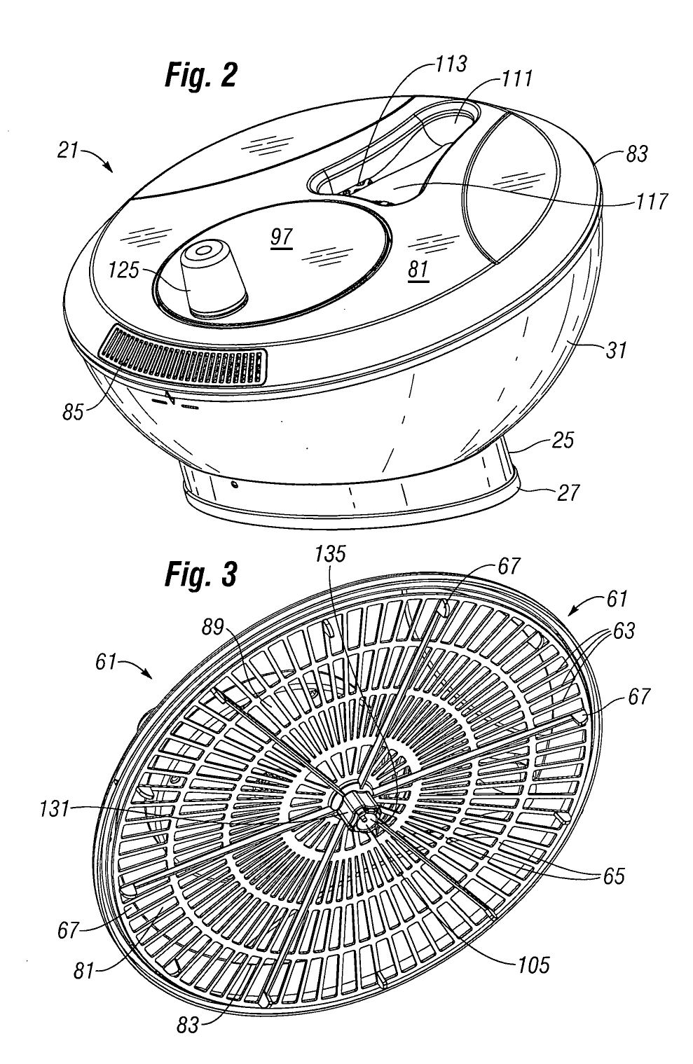

Referring to FIG. 2, a view of the salad, rice and other foods washer and spinner 21 in assembled view is seen. The tilt of the bowl member 31 is readily noticeable. If the bowl member 31 is filled, it can be seen that, due to the tilt, the bottom of the outlet grille 85 will mark the level of water horizontally across the bowl member 31. The user, if more effective, and even if the bowl member 31 is fixed with respect to the base member 25, place the salad, rice and other foods washer and spinner 21 on a more tilted or less tilted surface as needed. A greater tilt can give a more impacting slosh on turning, while a lesser tilt will give a less impacting more swirling effect. Notice that the depression 111 forms a flow trough when seen with the free standing tilt seen in FIG. 2, and that the flow through slot 113 lies at the bottom of the incline of the depression 111. In the position seen in FIG. 2, the salad, rice and other foods washer and spinner 21 can be placed in sink or basin, with a steady flow of water into the depression 111 while the rotatable handle 125 can be easily used to drive disk 97 to turn the basket member 35. As this occurs, water will exit through the outlet grille 85.

Referring to FIG. 3, a perspective view looking at the bottom of the basket drive lid 61 while it is still mechanically engaged with the cover 81 is shown. The outer periphery 81 of the cover 81 is seen through the spaces between the series of radial ribs 63 and series of circumferential ribs 65 of the basket drive lid 61. At the center, the underside center of the basket drive lid 61 is seen as having a rectangular cross sectional fitting 131 to provide cross sectional length for increased integrity for engagement with the lower basket lid 61 and stirring paddle member 51 drive fitting 105. A quick release 135 is seen as a slightly longer extension with an angled locking member for engaging the basket drive lid 61 onto the drive fitting 105. With this configuration, the removal of the cover 81 will cause the automatic removal of the basket drive lid from the basket 35.

The basket drive lid 61 is stably attached to and supported by the cover 81. The basket 35 central rotational aperture 43 fits over a projection (not yet shown) at the bottom inside of the bowl member 31. However, when the basket drive lid 61 and stably attached cover 81 is placed over the basket 35, the basket 35 shifts about one centimeter from a leaning position due to the tilt of the bowl member 31, into a rotational locking position with the basket drive lid 61. The lid 81 may have a rotational keyed position with respect to the bowl member 31. When the lid 81 is securely placed with respect to the bowl member 31, the basket drive lid 61 will automatically rotationally lock with the basket 35. Note that the series of downwardly directed locating lugs 67 have an exterior inwardly tapering surface to help it enter and register within the basket member 35.

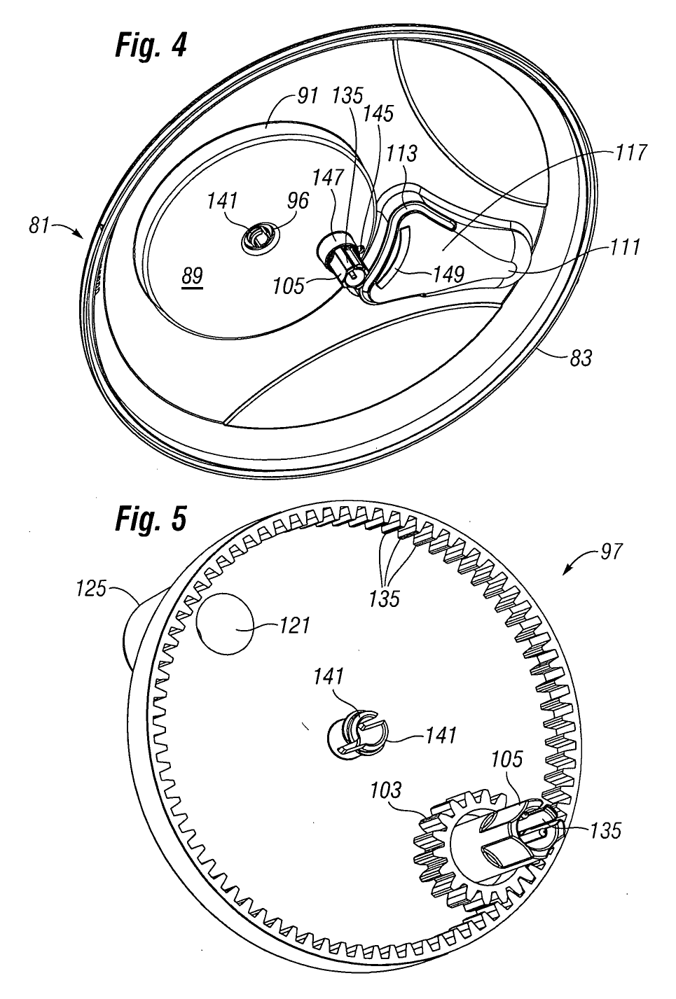

Referring to FIG. 4, a view of the underside of the lid 81 is seen. Through the drive disk anchoring aperture 96, a drive disk 97 rotational snap engagement member 141 is seen. The rotational snap engagement member 141 holds the drive disk 97 in place, but allows it to be removed for cleaning or if it is needed to be removed for periodic maintenance. A series of drainage holes 145 are shown to allow any moisture to escape from the circular depression flat space 89.

The cantilever brake portion 117 of the depression 111 is seen as having a wear pad 149 which is seen to be a thickened material and is expected to bear all of the frictional force against the basket drive lid 61 when depressed from the top side. The wear pad 149 may have a shape to cause the wear to occur predominantly in its center and to inhibit catching engagement. Further, the wear pad 149 may be located over one of the series of circumferential ribs 65 to insure that an uninterrupted smooth braking action may be applied.

Referring to FIG. 5, an underside of the drive disk 97 reveals a set of circumferentially inwardly disposed drive teeth 153 on the driven gear 103. The orientation of the drive disk 97 and driven gear 103 is similar to the orientation seen in FIG. 4, but with the cover 81 and circular depression flat space 89 member removed. Thus, the driven gear 103 is shown in a position similar to that which it would be located if it was being driven by the drive disk 97 while being rotationally held in place by the lower boss 147. As the drive disk 97 turns about the axis of the rotational snap engagement member 141, the driven gear 103 turns. As can be seen, adjustment of the size of the driven gear 103 and overall size of the drive disk 97 and its circumferentially inwardly disposed drive teeth 153 will dictate the number of turns of the driven gear 103 for each turn of the drive disk 97.

Also seen is a closeup view of the quick release 135. Quick release 135 is cantilevered from one side of the overall generally square drive fitting 105 so that a user merely needs to urge the single cantilevered spring inward to release the basket drive lid 61 from its mechanical connection with the cover 81. The inside of the upwardly projecting member 121 can be seen as a hollow bore with internal pegs to engage complementary members on the stirring paddle 51.

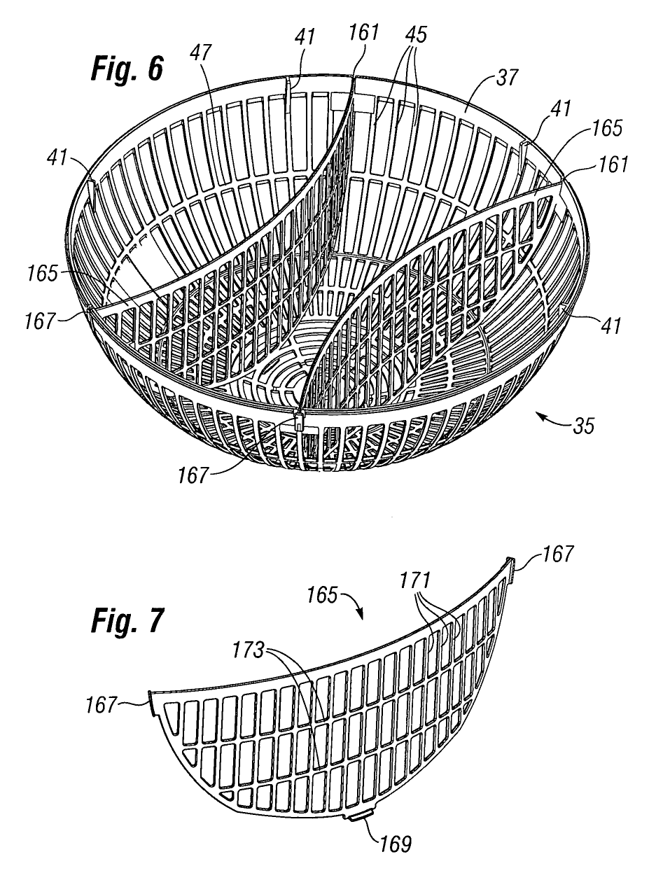

Referring to FIG. 6, an expanded view of the basket 35 is seen to illustrate further details. Basket 35 has a series of slots 161 which are best seen on the far side of the basket 35. The slots 161 accommodate a pair of dividers 165 which can partition the space within the basket 35 roughly into thirds. The dividers 165 have a pair of end tabs 167 which secure the dividers 165 into the slots 161 from a position out side of the upper rim 37.

Referring to FIG. 7 further details of one of the dividers 165 is seen. At the bottom of the divider 165 a laterally projecting tab 169 is seen. The laterally projecting tab 169 has the capability of inserting into one of several spaces at the bottom of basket 35 in order to somewhat limitingly adjust the shape of the resulting pockets formed with respect to the space in between the divider 165 and the inside of the basket 35. Divider 35 is seen as having vertical members 171 and horizontal members 173, however any structure is acceptable. It is preferable that the structure be a flow-through structure for maximum cleaning.

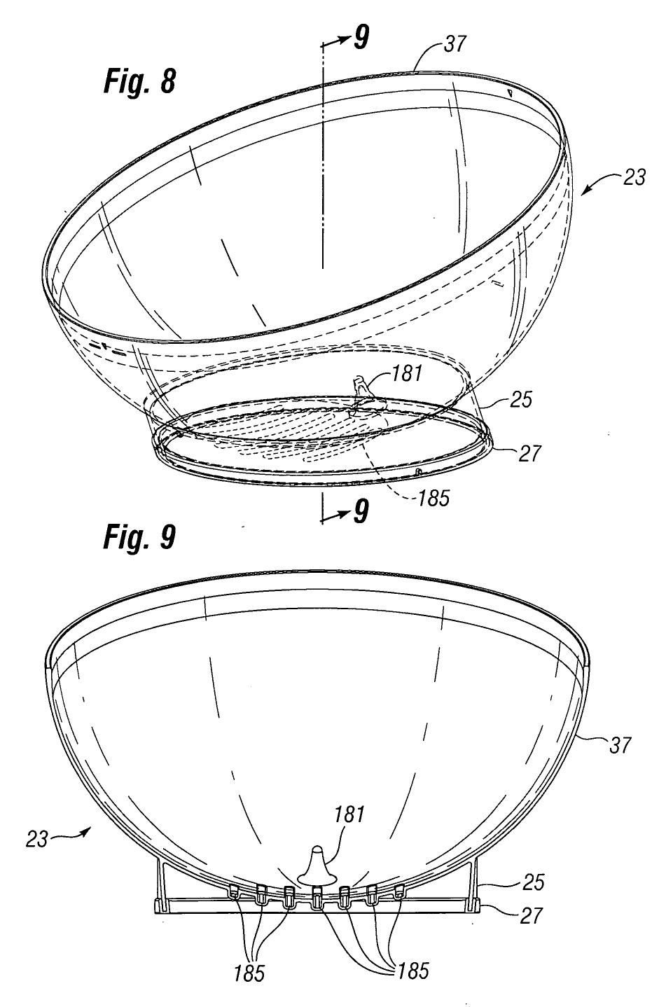

Referring to FIG. 8, a lower view looking up into the bowl assembly 23 is shown. Seen in section is a rotational support cone projection 181 which engages central rotational aperture 43 in basket 35 at the center of basket 35 and provides a low friction rotatability for the basket 35 within the bowl 37. Also seen at the bottom of the bowl 37, within perhaps within the confines of the base member 25, is a section of troughs 185 meant to form a natural trap for any particulate matter which is heavier than water. Particulates which are lighter than water are very likely to flow out of the outlet grille. The depth and width of the troughs 185 are such that particulate matter is very likely to remain undisturbed despite the continued turning of the basket 35. If a large amount of heavy debris is collected at the beginning of the washing operation, the basket can be easily removed by removing the cover 81, then lifting out the basket 35 and simply washing the bowl 37 with tap water at an angle so that water can flow longitudinally through the troughs 185 to clean them out.

Referring to FIG. 9, a sectional view taken along line 9-9 of FIG. 8 illustrates the orientation of the troughs 185 with respect to the rotational support cone projection 181. The troughs 185 can be in any orientation, but an orientation where the basket 35 turning direction and water flow approaches the troughs 185 laterally is believed to be advantageous in giving any trapped debris the best chance for being easily removed from any swirling water in the bowl 37.

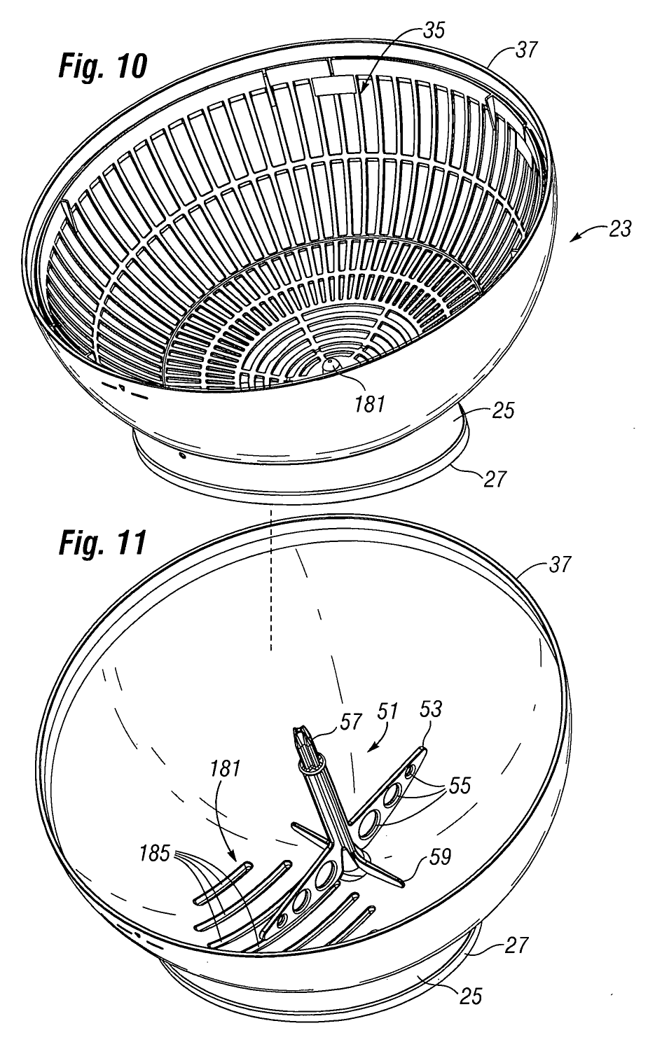

Referring to FIG. 10, a perspective upper view looking down into the bowl assembly 23 with the basket 35 loaded into place, is shown. The central rotational aperture 43 (not seen directly in FIG. 10) is brought down over the rotational support cone projection 181 which can be partially seen. In this position, the basket 35 is ready for loading food items to be washed. Note the even and close relationship between the basket 35 and the bowl 37.

Referring to FIG. 11, a perspective upper view looking down into the bowl assembly 23 with the basket 35 removed and with the optional stirring paddle member 51 loaded into place over the rotational support cone projection 181 which is only partially seen by a portion of its base. The top of the debris trapping troughs 185 can be seen for the first time from above. Note that the troughs are at the gravitational bottom of the bowl 37 and that the debris trapping troughs generally lie within a circular flattened area 191. Note also that the series of blade projections 53 sweep generally laterally across the troughs. Note also that the detail of the upper insertion portion 57 of the stirring paddle member 51 may ideally provide a slip fit into the drive fitting 105 rather than become lifted out of the bowl 37 when the cover 81 is removed.

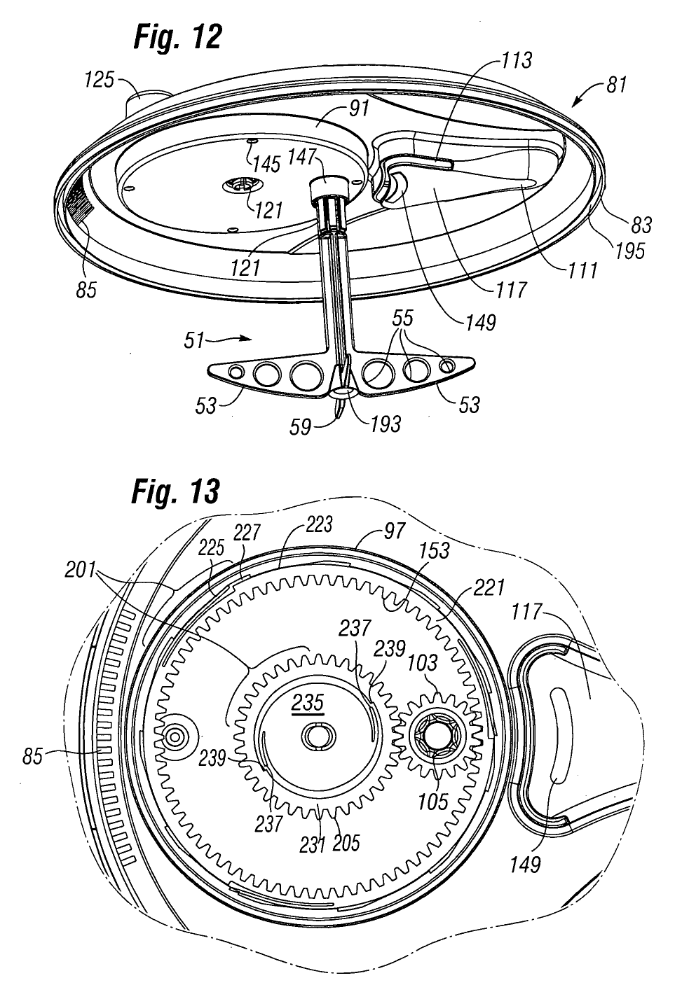

Referring to FIG. 12, a view of the underside of the cover 81 illustrates the stirring paddle member 51 shown in a slip fit connection with the drive fitting 105. For the first time the lower rotational support cone projection 181 pivot fitting 193 is seen fully. Also seen is a bowl engagement channel 195 which will help to insure a stable fit over the upper rim of bowl member 31.

In FIGS. 13-16, two methods of achieving twin speed action in accord with the direction of turn of the drive disk 97 will be illustrated. Referring to FIG. 13, a bi-directional ratchet arrangement 201 is seen. A center gear 205 is provided to drive the driven gear 103, in addition to the circumferentially inwardly disposed drive teeth 153. Rather than a direct connection between the circumferentially inwardly disposed drive teeth 153 and the drive disk 97, the circumferentially inwardly disposed drive teeth 153 are formed on a first inner ratchet ring 221. A first outer ratchet ring 223 is provided integrally with the drive disk 97. The first inner ratchet ring 221 has a number of cantilever spring projections 225 extending from the first inner ratchet ring 221 and to engage a groove 227 in the first outer ratchet ring 223. From the orientation seen in FIG. 13, only counterclockwise movement of drive disk 97 and first outer ratchet ring 223 will cause the circumferentially inwardly disposed drive teeth 153 to drive the drive fitting 105 counterclockwise. A clockwise movement of the drive disk 97 and first outer ratchet ring 223 will not cause the first inner ratchet ring 221 to move.

A smaller version of this arrangement is seen with respect to center gear 205. Center gear 205 is supported by a second outer ratchet ring 231. A second outer ratchet ring 233 is provided integrally with a hub 235 connected directly to the drive disk 97 near its center. The second outer ratchet ring 231 has a number of cantilever spring projections 237 extending from the second inner ratchet ring 231 and to engage a groove 239 in the second outer ratchet ring 231. From the orientation seen in FIG. 13, only clockwise movement of drive disk 97, hub 235 and second inner ratchet ring 233 will cause the circumferentially outwardly disposed drive teeth 205 to drive the drive the second outer ratchet ring 231 to enable the drive fitting 105 to turn clockwise.

Note that in accord with the ratio of teeth shown, the movement of the circumferentially inwardly disposed drive teeth 153 against the drive fitting 105 causes the drive fitting 105 to turn a little less than four times for each revolution of the drive disk 97. However, when the teeth of the center gear 205 is driving the drive fitting 105 in the other direction, the drive fitting 105 is caused to turn a little less than two times for each revolution of the drive disk 97. Thus, the combination of clutches 221, 223, 231 and 233 enables two speed differential direction turning of the drive fitting 105 and thus the basket 35.

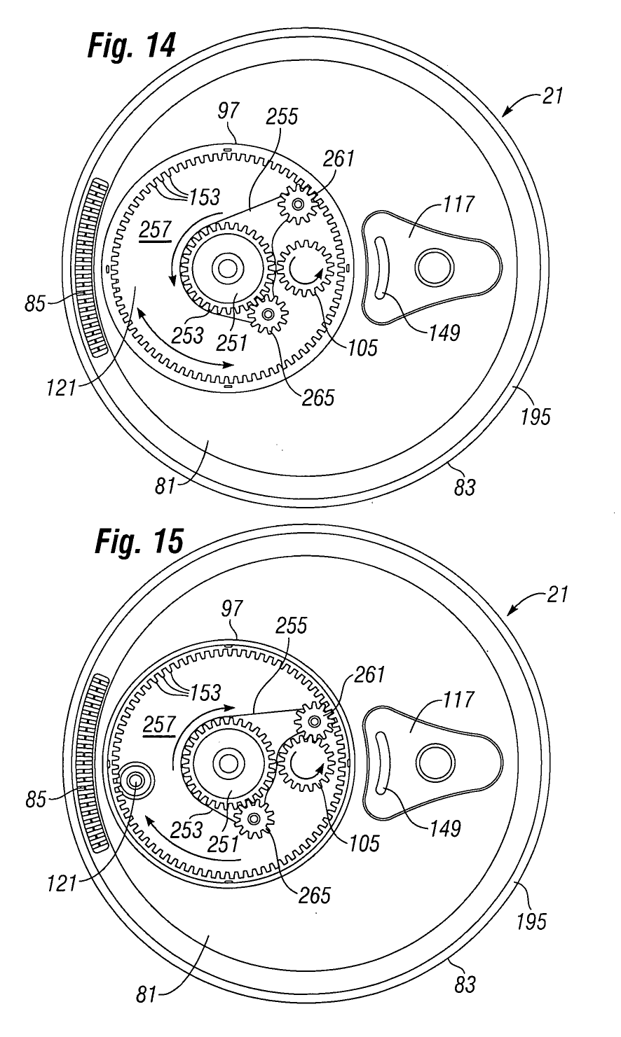

Referring to FIG. 14, a second twin speed gear arrangement is shown. As in FIG. 5, drive disk 97 includes circumferentially inwardly disposed drive teeth 153. The center of the drive disk supports a hub member 251 which is fixed to the drive disk 97 and turns as the drive disk 97 turns. Hub member 251 includes gear teeth 253. An angled gear support 255 is shown pivotally mounted about the center of rotation of the drive disk 97 and below the hub member 251 and an underside surface 257 of the drive disk 97. The angled gear support 255 can be optionally located to the side of hub member 251 facing away from the drive disk 97.

The angled gear support 255 provides angular displacement and differential distance from center, to a first intermediate drive gear 261 and a second intermediate drive gear 265. In FIG. 14 it can be seen that first intermediate drive gear 261 is engaged with respect to the circumferentially inwardly disposed drive teeth 153. Also, second intermediate drive gear 265 is engaged with respect to circumferentially outwardly oriented gear teeth 253 the hub member 251. The angled gear support 255 keeps the drive gears 261 and 265 engaged with the drive teeth 153 and drive teeth 253, respectively. The angled gear support 255 is allowed to pivot with respect to hub member 251 and drive disk 97. Even with no movement of drive disk 97, the angled gear support 255 can move over a limited angular displacement of about thirty degrees while the drive gears 261 and 265 turn against their respective teeth 153 and 253.

The lower basket lid 61 and stirring paddle member 51 drive fitting gear 105 is displaced inwardly from the circumferentially inwardly disposed drive teeth 153. This can be accomplished by providing a slightly larger diameter drive disk 97, since the drive fitting 105 will generally, absent additional gearing, be located at the center of axis of spin of the basket 35 or stirring paddle member 51. Other variables which may be changed include the diameter of the drive fitting 105. Note that in FIG. 14, the drive fitting 105 is not linked to the drive teeth 153. The only way that the drive bearing 105 can turn is by linking the turning of the drive disk 97 to it via (a) drive teeth 153 turning of drive gear 261 with drive gear 261 in drivable contact with drive fitting 105, or (b) drive teeth 253 turning of drive gear 265 in drivable contact with drive fitting 105.

A combination of either some frictional contact of the drive disk 97 with angled gear support 255 or drive gear 261's contact with drive teeth 153 will cause the angled gear support 255 to move slightly with the drive disk 97 between a middle position shown in FIG. 14, to a position where drive gear 261 makes contact with drive fitting 105 and back through about thirty degrees where drive gear 265 makes contact with drive fitting 105.

Thus it can be seen from the perspective of FIG. 14 that clockwise movement of drive disk 97 enables transmission of the drive teeth 153 via the first intermediate drive gear 261, to the drive fitting 105 which will produce about four turns of the drive fitting 105 for each turn of the drive disk 97. Similarly, counterclockwise movement of drive disk 97 enables transmission of the drive teeth 253 via the second intermediate drive gear 265, to the drive fitting 105 which will produce about two turns of the drive fitting 105 for each turn of the drive disk 97, so that dual speed can be achieved.

Referring to FIG. 15, a view similar to that in FIG. 14, illustrates clockwise movement of drive disk 97 causing contact between the drive teeth 153 via the first intermediate drive gear 261 to the drive fitting 105. Note that second intermediate drive gear 265 has moved out of contact with drive fitting 105 and simply spins freely due to continued contact with drive teeth 253.

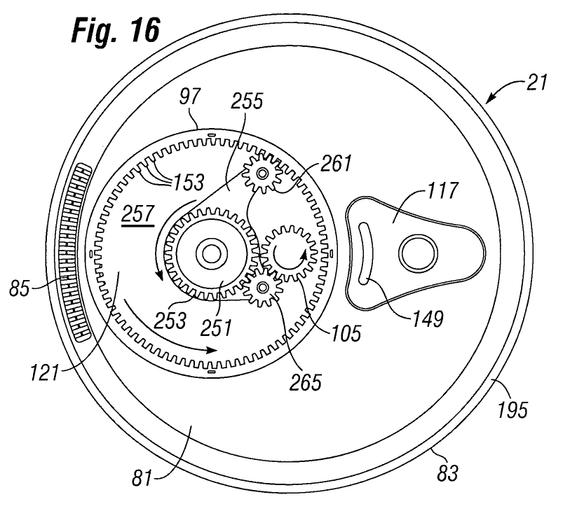

Referring to FIG. 16, a view as in FIGS. 14 and 15 illustrates counterclockwise movement of drive disk 97 causing contact between the drive teeth 253 via the second intermediate drive gear 265 to the drive fitting 105. Note that first intermediate drive gear 261 has moved out of contact with drive fitting 105 and simply spins freely due to continued contact with drive teeth 153.

While the present invention has been described in terms of a structure, device and process for constructing and using a salad, rice and other foods washer and spinner, one skilled in the art will realize that the structure and techniques of the present invention can be applied to many structures and devices which are used in the kitchen, and particularly where gearing, balance and water flow through are needed.

Although the invention has been derived with reference to particular illustrative embodiments thereof, many changes and modifications of the invention may become apparent to those skilled in the art without departing from the spirit and scope of the invention. Therefore, included within the patent warranted hereon are all such changes and modifications as may reasonably and properly be included within the scope of this contribution to the art.

What is claimed:

1. A foods washer and spinner for salad, rice and other foods comprising:
a bowl assembly including a base member for gathering support from at least one of a flat surface and a slanted surface, and a bowl member supported by said base member at an angle with respect to said base member whereby said bowl member has a tilted axis;
a basket assembly having a basket and a lid member securely fittable over said basket, said basket assembly rotatable within said bowl member;
a lid removably fittable to said bowl member and generally, with said bowl member and said lid enclosably surrounding said basket assembly, said basket assembly rotatable within said basket assembly when surroundably enclosed by said bowl assembly;
a mechanical assembly, manually actuatable from outside said bowl assembly to cause said basket assembly to turn within said bowl assembly.

2. The foods washer and spinner for salad, rice and other foods as recited in claim 1 wherein said lid has a liquids entry opening on an upper side of said lid, and wherein said lid has an outlet grille on a lower side of said lid.

3. The foods washer and spinner for salad, rice and other foods as recited in claim 1 wherein said mechanical assembly, manually actuatable from outside said bowl assembly to cause said basket assembly to turn within said bowl assembly includes a drive disk rotatably supported by said lid, said drive disk having gears which drive a driven gear connected to a drive fitting, said drive fitting rotatably engaging said basket assembly.

4. The foods washer and spinner for salad, rice and other foods as recited in claim 1 and further comprising a rotational support cone projection attached to said bowl member and wherein said rotational support cone projection engages an aperture at a rotational center of said basket member.

5. A foods washer and spinner for salad, rice and other foods comprising:
a bowl assembly including a base member for gathering support from at least one of a flat surface and a slanted surface, and a bowl member supported by said base member at an angle with respect to said base member whereby said bowl member has a tilted axis;
a stirring paddle member having a series of blade projections and having a first end and a second end, said second end rotatably supported by said bowl member; and
a lid removably fittable to said bowl member and generally, with said bowl member enclosably surrounding said stirring paddle, said stirring paddle rotatable within said basket assembly when surroundably enclosed by said bowl assembly and said lid;
a mechanical assembly, manually actuatable from outside said bowl assembly to cause said stirring paddle to turn within said stirring paddle member.

6. The foods washer and spinner for salad, rice and other foods as recited in claim 1 and further comprising a rotational support cone projection attached to said bowl member and wherein said rotational support cone projection engages a pivot fitting at said second end of said stirring paddle member.
